(19) United States
(12) Patent Application Publication
(10) Pub. No.: US 2018/0061374 A1
(43) Pub. Date: Mar. 1, 2018

(54) Adaptive Screen Interactions

(71) Applicant: Microsoft Technology Licensing, LLC, Redmond, WA (US)

(72) Inventors: Gregg Robert Wygonik, Duvall, WA (US); Christian Klein, Duvall, WA (US); Sophors Khut, Seattle, WA (US)

(73) Assignee: Microsoft Technology Licensing, LLC, Redmond, WA (US)

(21) Appl. No.: 15/244,843

(22) Filed: Aug. 23, 2016

(51) Int. Cl. G09G 5/373; G06F 1/16; G09G 5/26

(52) U.S. Cl. CPC G09G 5/373; G06F 1/1616; G06F 3/0482; G09G 5/26; G09G 2320/028; G06F 1/1677

(57) ABSTRACT

A computing device that processes data from multiple sensors to modify image elements on a display for viewing is described. In implementations, a display adapter circuit in a computing device processes hinge data from a first sensor and orientation data from a second sensor and infers a viewing angle to output the image elements for display. In implementations, the display adapter circuit adapts the display device to enable display of the image elements at the inferred viewing angle while the computing device is between a closed position and a fully open position. The computing device can also or instead be implemented to transition display of modified image elements while first and second housings of the computing device move relative to one another.

### BACKGROUND

The design variety of various kinds of computing devices is ever increasing. For instance, computing devices often include a hinge for opening and closing the device. Users desiring to check the time, view a message, or make selections on a display of traditional hinged computing devices are often required to fully open the device before the display is available to present information and to receive a user input. Thus, traditional computing devices that include a hinge may be inefficient and can lead to user frustration by requiring the computing device to fully open before user inputs can be received and general interaction can occur.

For example, a typical clamshell device includes two parts connected by a hinge and a primary display on an inside surface. Accordingly, the primary display is hidden from view when the clamshell device is closed. When the typical clamshell device is partially open, the primary display is inactive. Information is not displayed in a manner that is legible or useful to user when a user attempts to “peek” at the primary display without fully opening the clamshell device. As a result, users are forced to fully open the device before the information is displayed and any associated interactions become usable. Thus, traditional techniques used for interacting with a typical clamshell device may be ineffective and can lead to user frustration.

### SUMMARY

A computing device that adapts a display device according to an inferred user's perspective while the computing device is between a closed position and a fully open position is described. In implementations, a display adapter circuit is configured to process hinge angle data from a first sensor and orientation data from a second sensor to infer a viewing angle to output image elements for display. The display adapter circuit of the computing device may then adapt the display device to enable display of the image elements at the inferred viewing angle while the computing device is between a closed position and a fully open position.

A computing device can be configured to perform adaptive display techniques including receiving, via a first orientation-determining technique, first orientation data indicative of a position of a first housing of the computing device relative to a second housing of the computing device. In implementations, the computing device also refines the position of the first housing relative to the second housing based on second orientation data detected by a second orientation-determining technique and modifies image elements on a display device of the computing device to enable viewing of the modified image elements in dependence upon the refined position of the first housing relative to the second housing. In implementations, a display adapter circuit is disposed in a computing device that is operable to receive device orientation data indicative of a position of a first housing of the computing device relative to a second housing of the computing device. The display adapter circuit in the computing device may also refine the position of the first housing relative to the second housing based on accelerometer data detected by the computing device and transition display of image elements among multiple modified states on a display device of the computing device during a change of the position of the first housing relative to the second housing.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIGS. 2A, 2B, and 2C are diagrams representing an example scenario for adapting a display of the computing device of FIG. 1 in accordance with one or more implementations.

FIG. 3 depicts a computing device in an example implementation to adapt a display to an inferred viewing angle.

FIGS. 4A and 4B are diagrams representing example scenarios for adapting display(s) of various computing devices in accordance with one or more implementations.

FIG. 5 is a flow diagram depicting a procedure in an example implementation in which image elements are modified for display in dependence upon a position of first and second housings of a computing device.

FIG. 6 is a flow diagram depicting a procedure in an example implementation in which image elements for display are transitioned among multiple modified states during a change in position of a computing device.

FIG. 7 illustrates various components of an example system that can implement aspects of the display adaption techniques described herein in accordance with one or more implementations.

### DETAILED DESCRIPTION

A typical clamshell device includes a primary display on an inside surface that is hidden from view when the clamshell device is closed. When the typical clamshell device is partially open, the primary display is often inactive thereby preventing the display from outputting content or receiving an input. Thus, when a user attempts to “peek” at the primary display of the typical clamshell device without it being fully open, information is not displayed in a manner that is legible or useful to user. Further, interacting with the primary display of the typical clamshell device is not enabled in positions between the closed and open positions thereby preventing gesture interactions. Additionally, when the typical clamshell device includes an active primary display and is partially open, the active primary display fails to adapt to a viewer and instead presents content that is hard to read or comprehend. As a result, traditional techniques to interact with a clamshell device require a user to fully open the device before the information is displayed and gesture interactions become usable. Thus, traditional techniques for interacting with typical clamshell devices may be ineffective and can lead to user frustration.

A computing device that adapts a display according to an inferred user's perspective while the computing device is between a closed position and a fully open position is described. In implementations, a display adapter circuit processes hinge angle data from a first sensor and orientation data from a second sensor and infers a viewing angle to output image elements for display. The display adapter circuit of the computing device may then adapt the display to enable display of the image elements at the inferred viewing angle. In one approach, the display adapter circuit enables interactive gestures related to the displayed image elements by reconfiguring a size and a shape of the displayed image elements in accordance with the inferred viewing angle. In this way, the display adapter circuit may enable interactive gestures via a display while the computing device is between a closed position and a fully open position.

The computing device can also be implemented to receive, via a first orientation-determining technique, first orientation data indicative of a position of a first housing of the computing device relative to a second housing of the computing device. In implementations, the computing device refines the position of the first housing relative to the second housing based on second orientation data detected by a second orientation-determining technique and modifies image elements on a display device of the computing device to enable viewing of the modified image elements in dependence upon the refined position of the first housing relative to the second housing. In one approach, modifying image elements includes distorting the image elements on the display device according to the inferred viewing angle. In this way, when viewed at the inferred angle, the image elements appear legible and understandable due to the distortion applied to the image elements.

In implementations, a display adapter circuit disposed in a computing device is configured to receive device orientation data indicative of a position of a first housing of the computing device relative to a second housing of the computing device. The display adapter circuit in the computing device may also refine the position of the first housing relative to the second housing based on accelerometer data detected by the computing device and transition display of image elements among multiple modified states on a display device of the computing device during a change of the position of the first housing relative to the second housing. By transitioning display of the image elements among the multiple modified states on the display device, the computing device is able to continuously adapt to be useful in a range of positions and postures, including while between ‘open’ and ‘closed’ positions.

Using the described circuitry and techniques, a computing device can perform various adaptive display techniques that cause a display of the computing device to output content at a particular viewing angle. For instance, the adaptive display techniques can be implemented to enable a user to view the display legibility when partially open. This is accomplished in part by modifying a size and/or shape of image elements (e.g., objects output for display) at a particular angle to compliment viewing. Generally, the circuity can be implemented in a computing device to compute the particular angle for viewing using two sensors that each determine an orientation of the device using different techniques.

Image elements for display can include elements that provide information and/or elements that are selectable to invoke actions, to name a few. Accordingly, regardless of whether image elements for display convey information to a user or provide an area for recognizing a gesture, the circuitry can be implemented to change a size and/or shape of the image element so that information appears correctly when viewed despite changes being made to the orientation of the computing device. In this way, the adaptive display techniques implemented by the circuitry can enable the display of the computing device to present information and process interactions even while it is difficult to see the entire display.

Employing the circuitry and techniques described herein enables a display of a computing device to continuously adapt to an inferred viewing position while the computing device is moved between ‘closed’ and ‘open’ positions. For instance, the circuitry can be implemented to modify image elements on a display in dependence upon an orientation of parts of the device relative to one another, a user's posture, and/or an orientation of the device relative to an external environment. In implementations, the circuitry modifies image elements on a display according to a position of an associated computing device in space such as whether the computing device is upright, upside down, etc. Techniques for adapting a display using the circuitry are discussed below.

In the following discussion, an example environment is first described that may employ the techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

Example Environment

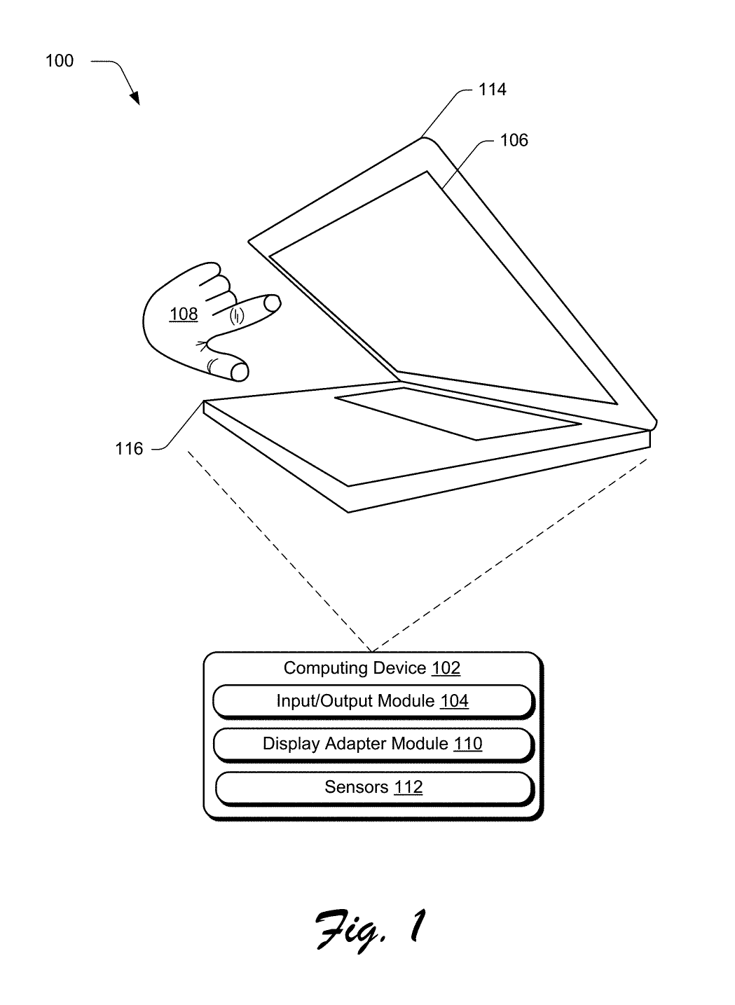

FIG. 1 is an illustration of an environment 100 in an example implementation that is operable to employ adaptive display techniques. The illustrated environment 100 includes an example of a computing device 102, an input/output module 104, a display device 106, a user's hand 108, a display adapter module 110, and sensors 112. As illustrated in FIG. 1, the computing device 102 further includes housings 114 and 116 that are connected to each other using a connecting mechanism (not shown) such as a hinge or other component that enables movement of the housings relative to one another.

The computing device 102 may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input/output module 104 that is representative of functionality to send and/or receive inputs and outputs to and/or from an operating system of the computing device 102. For instance, the input/output module 104 can be responsible for recognizing interactions, such as gestures. In one implementation, the input/output module 104 may be configured to receive an input to enable gesture recognition while the computing device 102 is between a closed and a fully open position. As will be discussed in more detail below, the input/output module 104 may also be configured to output image elements on the display device 106 in accordance with a result of the display adapter module 110.

As illustrated the computing device 102 includes the display device 106 which is representative of functionality to present image elements for display. The display device 106 can include a digitizer panel, a monitor, touch screen, or projector, and so forth and can be configured for use with or without a computing device. As explained in detail below, the computing device 102 may include one or more displays on an internal surface, an external surface, and/or an edge surface of the computing device 102. Accordingly, the display adaption techniques can be implemented to modify a display disposed on any surface of the computing device 102 including an internal display, an external display, an edge display, or a combination thereof.

The user's hand 108 generally represents a user which can interact with the computing device 102 to invoke actions via selections on the display device 106. In addition or alternatively, the user's hand can adjust a position of the computing device such as by moving one or more of the housings 114 or 116. In implementations, however, the user's hand 108 and a user in general is not required for the display adapter module 110 to perform the various techniques described herein.

The computing device 102 is also illustrated as including the display adapter module 110 for employing various techniques described herein. The display adapter module 110 is representative of functionality of the computing device relating to adapting the display device 106. For example, the display adapter module 110 may be configured to perform one or more actions responsive to processing data from the sensors 112, such as to modify image elements, to infer a viewing angle for outputting image elements for display, to determine device orientation, just to name a few. By processing data from the sensors 112 over a period of time and during changes to a position of the computing device 102 (e.g., relative to a user and/or relative to an environment), the display device 106 can be continuously modified to enable interactions and/or viewing related to the display device 106.

In an implementation, the display adapter module 110 receives data from the sensors 112 and employs two or more different orientation techniques. Generally, each sensor can capture data that is usable by the display adapter module 110 to determine different orientation results. For instance, data from one of sensors 112 can be indicative of how ‘open’ the device is while data from another sensor can indicate a position of the device relative to an external environment. The display adapter module 110 determines a position of the computing device 102 using the two orientation techniques and modifies the display device 106 to include image elements that are configured to operate in one of multiple modes that reflect different degrees of modification. In an implementation, the display adapter module 110 communicates (e.g., exchanges data) with the sensors 112 and with other modules of the computing device 102, such and the input/output module 104, to cause the computing device to enable interactions and viewing while partially open. As described herein, ‘partially open’ can refer to any position between a closed position and a fully open position.

A variety of different techniques may be employed by the sensors 112 to receive signals available for detection in a vicinity of the computing device 102. For example, the display adapter module 110 may employ the sensors 112 to receive signals indicative of an orientation of the computing device 102. In implementations, the sensors 112 may assume a variety of different configurations to detect the signals and may include a hinge sensor, an accelerometer(s), a camera, a touchscreen sensor, a capacitive sensor, or a combination thereof. Further discussion of these sensors may be found in relation to the following figures.

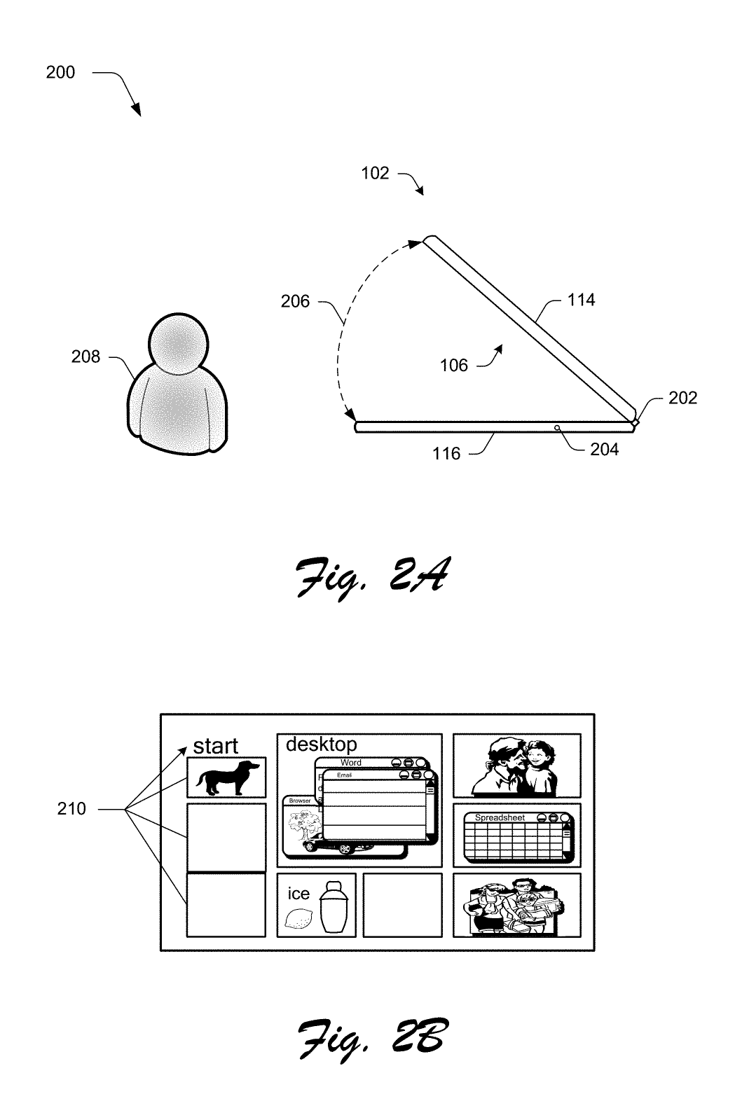

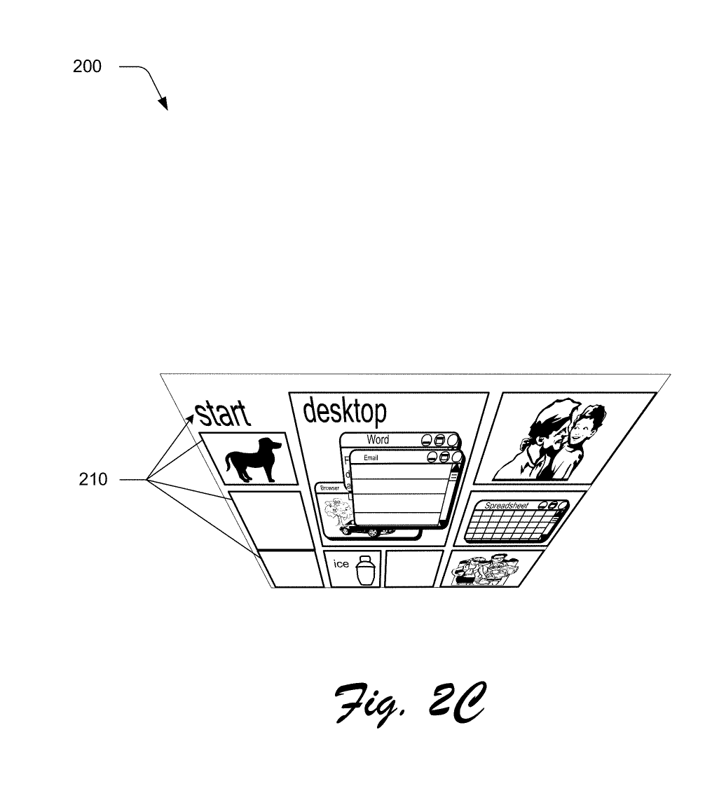

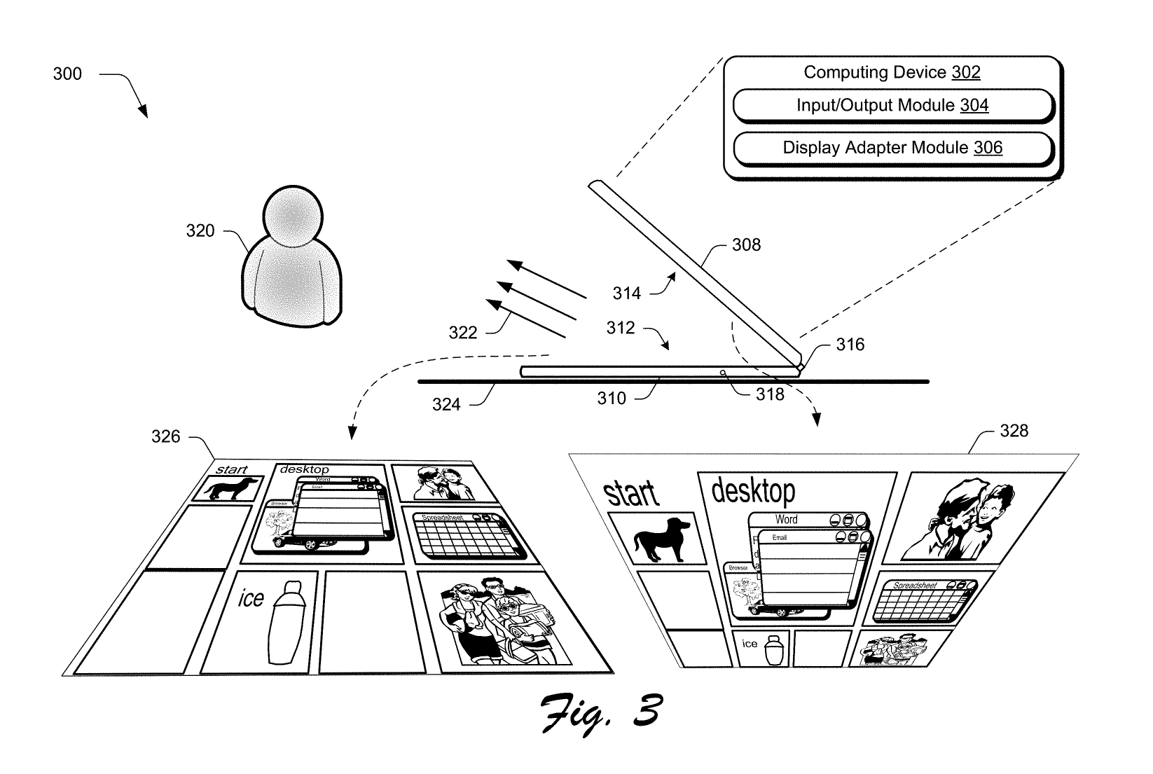

In one approach, the display adapter module 110 receives data from a hinge sensor that indicates an angle of opening of the computing device 102 and also receives data from an accelerometer that indicates an orientation of the device relative to a user and/or an external environment. The display adapter module 110 can also process both sets of data to infer an angle for viewing the display device 106. The inferred viewing angle can be representative of a position that is optimal for viewing the display device 106 when the computing device 102 is not fully open. Thus, when a user views the display device 106 at the viewing angle determined by the display adapter module 110, image elements are output such that they appear legible and readable (i.e., represent minimal, if any, distortion) when viewed at the inferred angle. When not viewed at the inferred angle, however, the image elements may appear distorted and ‘out of shape’ due to the modifications applied to the image elements. Thus, image elements can be modified in shape and size to appear correctly from a particular angle thereby providing the user with information and/or interactions while the computing device is not fully open. These and other features will be discussed in relation to FIGS. 2A, 2B, 2C, 3, 4A, and 4B below.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the adaptive display techniques described below are platform-independent, meaning that the techniques may be implemented on a variety of commercial computing platforms having a variety of processors.

FIGS. 2A, 2B, and 2C are diagrams representing an example scenario 200 for adapting a display of the computing device of FIG. 1 in accordance with one or more implementations. In FIG. 2A, the computing device 102 is illustrated as including the display device 106, housings 114 and 116, and sensors 202 and 204.

In the example 200 of FIG. 2A, the display adapter module 110 can be implemented to receive device orientation data from sensor 202 that indicates a position 206 of housing 114 relative to housing 116. In some instances, the device orientation data can represent an angle of separation between the housings, a distance between the housings, or other measurement that determines how ‘open’ the computing device is at a given time.

In the example 200, the display adapter module 110 also receives orientation data from sensor 204 that indicates a position of the computing device 102 relative to an external environment. For instance, the sensor 204 can send data to the display adapter module 110 that indicates whether the computing device 102 is being held by a user 208. Additionally or alternatively, the data from sensor 204 may indicate an orientation of the computing device 102 in space such as whether the computing device 102 is on a surface. Thus, in implementations the display adapter module 110 can combine data from different sensors to determine whether the computing device 102 is being held or is placed on a surface. The combined sensor data enables the display adapter module 110 to modify image elements output on the display device 106 according to different usage scenarios i.e., whether a user is sitting, standing, holding, or simply viewing the computing device on a surface.

In implementations, these different usage scenarios correlate to modified states that can be applied to the image elements for display. Each of the multiple modified states for the image elements represent different degrees of modification for the image elements. For instance, when an image element includes text, one of the modified states for the text identifies at least two dimensions at which to modify the text for display on the display device. In at least some implementations, modified states are continuously calculated by the display adapter module responsive to changes in positions of the housings relative to each other and/or responsive to a change in position of the computing device relative to a user and/or an environment. Thus, the display device 106 can adapt to changes in the position 206 between housings relative to each other by applying two or more of the modified states to image elements output for display during the change of the position of the first housing relative to the second housing.

As illustrated in FIG. 2A, the sensor 202 is generally disposed in a hinge portion of the computing device that connects housings 114 and 116 while sensor 204 is shown associated with the housing 116. In implementations, sensors 202 and 204 can be configured in various ways including being disposed in other areas of the computing device. In one specific implementation, sensor 202 is configured as a hinge sensor that captures an angle between the housings 114 and 116 and sensor 204 is configured and as accelerometer that captures orientation data. In some implementations multiple sensors can be used as the sensor 202 and/or the sensor 204. For instance, in embodiments one or multiple sensors can be implemented into housing 114 and/or housing 116 to improve accuracy of the orientation data. In one specific implementation, the sensor 202 can provide the functionality of the sensor 204 such that a single sensor is usable by the display adapter module 110 for detecting device orientation data, accelerometer data, and/or other orientation data.

Generally, the display adapter module 110 is configured to output image elements for display on the display device 106 at a particular angle for viewing. FIG. 2B depicts an adapted display device for the example scenario 200 in which image elements 210 include modifications in at least two dimensions. Here, the image elements 210 appear natural and undistorted in both shape and size because the display has been adapted to an inferred viewing angle determined by the display adapter module 110. In implementations, the image elements 210 are modified (e.g., distorted, warped, relocated, etc.) in accordance with a modified state determined by the display adapter module 110. In the example of FIG. 2B, the ‘Start’ image element can be representative of a gesture element because it is selectable. A selectable region associated with the ‘Start’ image element can, for instance, be modified in at least two dimensions so that the selectable area is larger in an x and/or y direction of the display device 106. Thus, the display adapter module 110 can progressively distort and move portions on the display that correspond to information and gestures.

FIG. 2C depicts an adapted display device for the example scenario 200 in which image elements 210 include modifications in at least two dimensions as viewed at a viewing angle other than the inferred viewing angle determined by the display adapter module 110. In the example of FIG. 2C, the ‘Start’ image element can be representative of a gesture element that is modified by the display adapter module 110 to enable easier selection by modifying a selectable area associated with the displayed element. In implementations, the display adapter module 110 can be configured to output less modification for image elements output nearer to the inferred viewing angle, and to output more modification to the image elements output further from to the inferred viewing angle.

FIG. 3 depicts generally at 300 a computing device 302 in an example implementation to adapt a display to an inferred viewing angle. Generally, the example implementation of FIG. 3 represents a dual display scenario where visual elements can be separately displayed on the different respective displays. The computing device 302, for example, represents a variation on the computing device 102. In this example, computing device 302 includes input/output module 304, display adapter module 306, housings 308 and 310, display devices 312 and 314, sensors 316 and 318, and user 320. As illustrated in FIG. 3, the computing device 302 is on a surface 322. Arrows 324 represent an inferred viewing angle at which image elements are directed for display. The inferred viewing angle generally corresponds to an angle at which the image elements are available for viewing by an eye of the user 320. Generally, the inferred viewing angle is a result of processing data from sensors 316 and 318 by the display adapter module 306 using any of the techniques described herein.

In implementations, when the user 320 views the display device 106 at the viewing angle determined by the display adapter module 110, image elements are output such that they appear legible and readable i.e., represent minimal, if any, distortion as discussed above in relation to FIG. 2B. However, when not viewed at the inferred viewing angle, the image elements may appear distorted and ‘out of shape’ due to the modifications applied to the image elements. To illustrate, FIG. 3 depicts presentations 326 and 328 which generally correspond to the display devices 312 and 314, respectively when viewed at a substantially different angle form the inferred viewing angle. In implementations, presentation 326 may instead appear split over portions of displays 312 and 314.

In the example depicted in FIG. 3, as a position of housing 308 changes relative to housing 310, each of displays 312 and 314 are continuously updated to output modified image elements. Here, the display adapter module 306 can be implemented to generate modification to image elements that enable user 320 to view display device 312 while continuing to ‘open’ and/or ‘close’ the computing device 302. In this example, the display device 314 will present modified image elements so that viewing remains legible in a range of positions. Thus, display devices 312 and 314 can adapt in accordance with a change in the position of the housing 308 relative to the housing 310. Although display devices 312 and 314 are illustrated in FIG. 3 as separate devices, in alternative embodiments a single display device can encompass multiple surfaces and/or housings of the computing device 302.

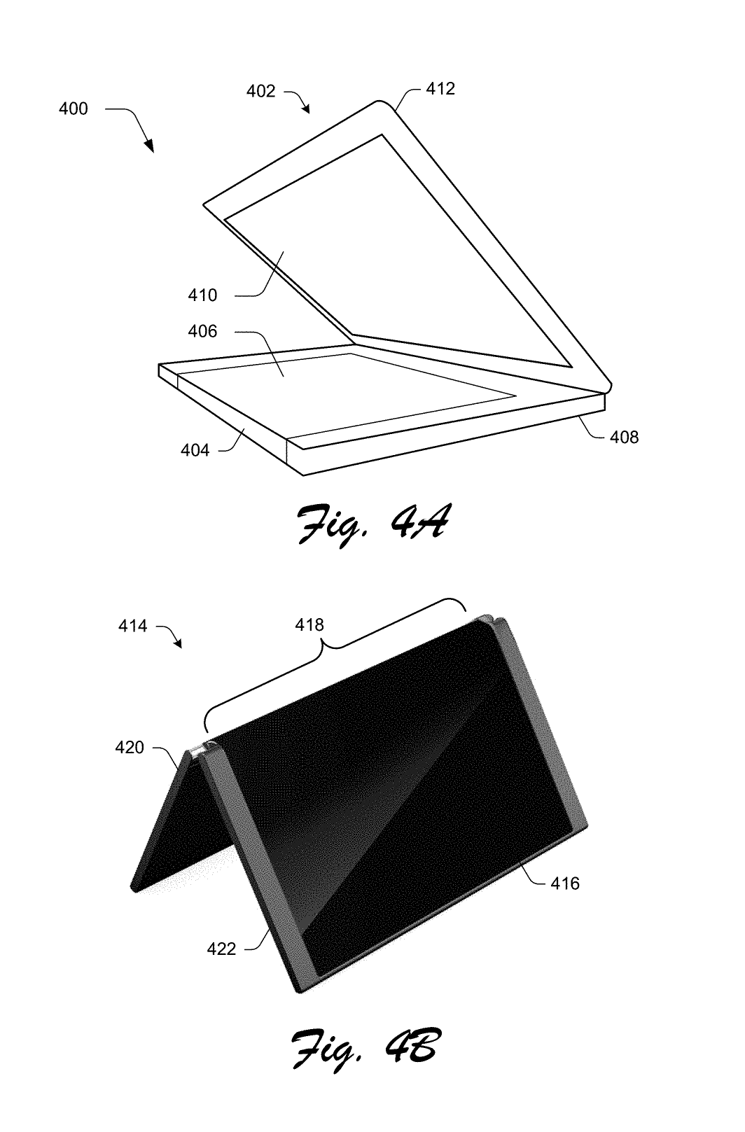

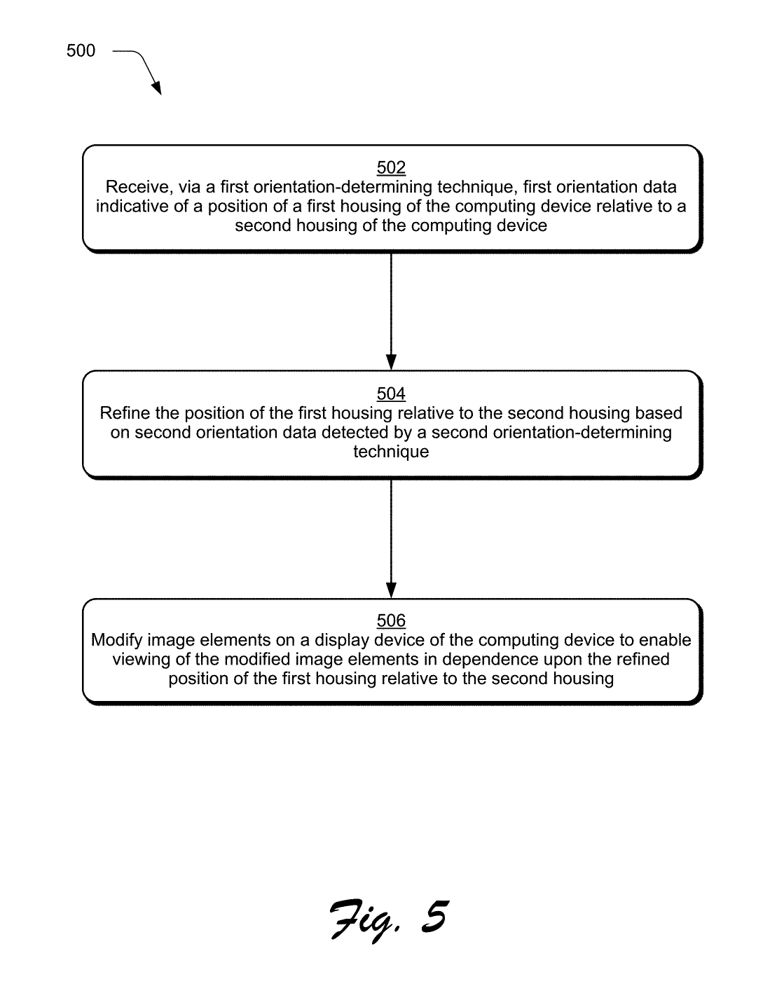

FIGS. 4A and 4B are diagrams representing example scenarios 400 for adapting displays of various computing devices in accordance with one or more implementations. Generally, FIG. 4A represents a computing device having multiple displays while FIG. 4B represents a computing device having a single continuous display over multiple surfaces and housings.

In the example shown in FIG. 4A, computing device 402 includes an edge display 404 and an additional display 406 on housing 408, as well as another display 410 on housing 412. Although not shown, the computing device 402 includes an input/output module, a display adapter module, and multiple sensors to provide adaptive display techniques as discussed herein.

In implementations, the computing device 402 can transition output of image elements from the edge display 404 to displays 406 and 410. For instance, image elements can first appear on the edge display 404, and then appear on one or more of displays 406 and 410 in response to a change in position between the housings 408 and 412. In one implementation, the edge display 404 and the additional display 406 can be combined as a single display in which the single display is disposed on an inside surface of the housing 408 and extends to an outer edge of the housing 408. Regardless of how implemented, the computing device 402 is operable to modify image elements on the edge display 404 and displays 406 and 410 while the computing device 402 is between a ‘closed’ and an ‘open’ position. In one specific implementation, the computing device 402 operates to modify image elements while the computing device is fully closed via the edge display 404. In this implementation, the edge display 404 can be modified to adjust output to an inferred angle determined by the display adapter module.

In one specific implementation, the transitioning of a display can include transitioning image elements among modified states starting on an external edge display 404 and extending to a primary display on an inside surface of the computing device 402. Of course, the display device may be configured as a continuous display that extends from the external edge of the device to an inside surface of the device, further discussion of which can be found in relation to FIG. 4B.

In implementations, the computing device 402 is also operable to modify image elements on the edge display 404 and displays 406 and 410 when ‘partially open’. In one specific example, housing 408 may open to about 30 degrees or less relative to housing 412. This can also be thought of a user ‘peeking’ since the opening to view the display is small. However, the adaptive display techniques described herein are not limited to any particular amount that a computing device is open but rather can be useful in a range of positions up to an including a fully open position when normal display of image elements is restored.

FIG. 4B illustrates an additional scenario in which computing device 414 includes a display device 416 over multiple surfaces. As illustrated, the computing device 414 includes a curved display portion 418 that spans housings 420 and 422. Thus, in implementations the display device 416 can be configured as a single display device that folds and/or bends in relation to the housings 420 and 422. In implementations, the computing device 414 can be configured like that of computing device 102 in FIG. 1 to adapt the display device 416 so that image elements are visible according to an inferred viewing angle. In implementations, the curved display portion 418 can include image elements having different degrees of modifications relative to other portions of the display device 416. Thus, the computing device 414 can implement the adaptive display techniques regardless of whether a display is positioned on an inside, outside, and/or edge surface, and even when a portion of the display device 416 is curved.

Various actions such as receiving, refining, modifying, adapting, transitioning, inferring, and so forth performed by various modules are discussed herein. It should be appreciated that the various modules may be configured in various combinations with functionality to cause these and other actions to be performed. Functionality associated with a particular module may be further divided among different modules and/or the functionality represented by multiple modules may be combined together into a single logical module. Moreover, a particular module may be configured to cause performance of action directly by the particular module. In addition, or alternatively, the particular module may cause particular actions by invoking or otherwise accessing other components or modules to perform the particular actions (or perform the actions in conjunction with that particular module).

Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

In portions of the following discussion, reference may be made to the examples of FIGS. 1-4. In at least some implementations, procedures 500 and/or 600 may be performed by a suitably configured computing device such as computing device 102 of FIG. 1, computing device 302 of FIG. 3, and computing devices 402 and 414 of FIGS. 4A and 4B having a suitably configured display adapter module, or as described in relation to FIG. 7.

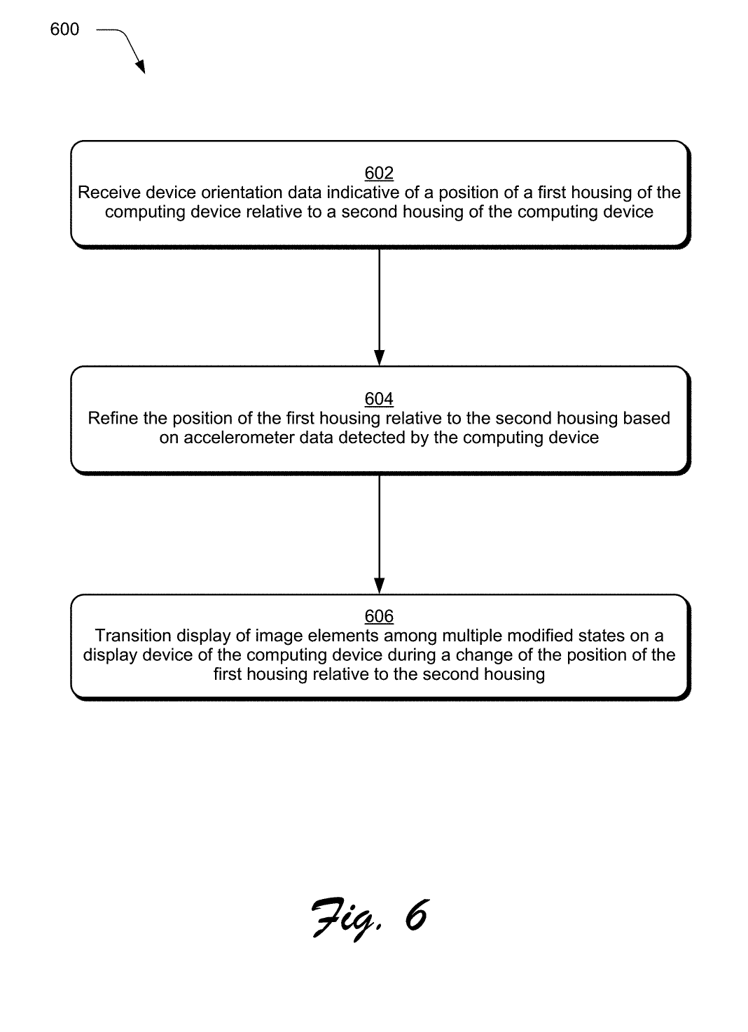

FIG. 5 is a flow diagram depicting a procedure in an example implementation in which image elements are modified for display in dependence upon a position of first and second housings of a computing device. Device orientation data indicative of a position of a first housing of the computing device relative to a second housing of the computing device is received via a first orientation-determining technique (block 502). For example, the display adapter module 110 may receive device orientation data from the sensor 202 that is indicative of a degree of opening between the housings 114 and 116. The device orientation data can be received at the display adapter module 110 responsive to a change in position between the housings 114 and 116 relative to each other.

The position of the first housing relative to the second housing is refined based on orientation data detected by a second orientation-determining technique (block 504). For instance, in one or more implementations, the display adapter module 110 processes the orientation data received from sensor 204 using any of the techniques described herein. In one approach, the display adapter module 110 adjusts the device orientation data indicative of the position of the first housing relative to the second housing to account for an orientation of the computing device relative to a user (e.g., the computing device is held) and/or an orientation of the computing device relative to an external environment (e.g., the computing device is being held while a user is standing). In embodiments, the display device 106 is adapted according to a result of the display adapter module which generally correlates the processed device orientation data and the orientation data to an inferred viewing angle for displaying images.

In implementations, image elements on a display device of the computing device are modified to enable viewing of the modified image elements in dependence upon the refined position of the first housing relative to the second housing (block 506). In one specific implementation, the display adapter module 110 determines a modified state for the image elements 210 while the computing device 102 is between ‘fully open’ and ‘closed’ positions. By including the display adapter module 110 in a computing device, the display adapter module 110 can be implemented to continuously update display of the modified image elements on the display device in accordance with a change in the position of the housings of the computing device.

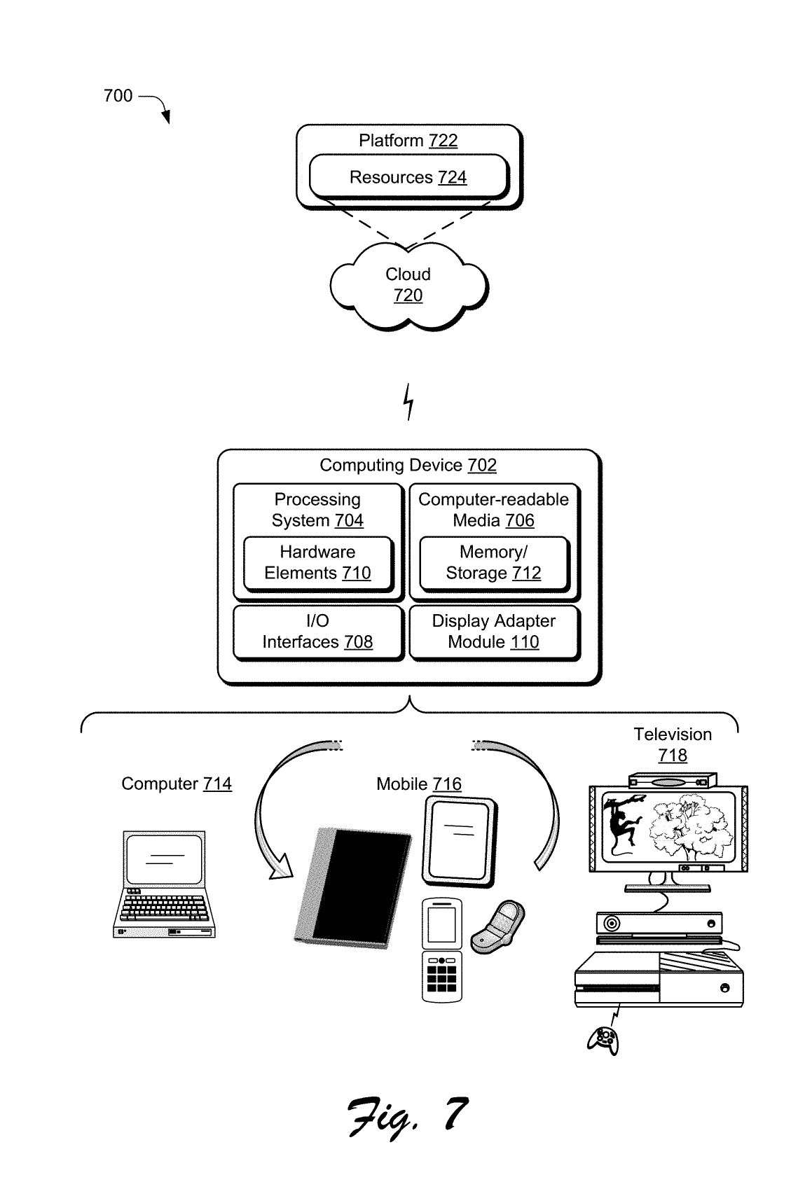

FIG. 6 is a flow diagram depicting a procedure in an example implementation in which image elements for display are transitioned among multiple modified states during a change in position of a computing device. Device orientation data indicative of a position of a first housing of the computing device relative to a second housing of the computing device is received (block 602). For example, the display adapter module 110 may receive device orientation data from one or more of the sensors 112 that is indicative of an amount of separation between the housings 114 and 116.

The position of the first housing relative to the second housing is refined based on accelerometer data detected by the computing device (block 604). For instance, the display adapter module 110 adjusts an indication of the position of the housings relative to each other. In an example, the display adapter module 110 uses both the accelerometer data and the device orientation data to correlate the combined data to a modified state for an image element for display. In this way, typical positions of a user and/or device can be taken into account when adapting the display. Therefore in this example, the display adapter module 110 can compute an amount of adjustment for image elements for display depending upon whether the user is holding, walking, standing, sitting, or other ranges of postures. In one specific example, refining the position can include using a camera to track a user's posture and determine their preferred computer position when standing and/or sitting, for instance. In addition, or alternatively, refining the position can include using behavior data for a user to leverage postures used in a variety of positions by a particular user when interacting with a computer.

Display of image elements are transitioned among multiple modified states on a display device of the computing device during a change of the position of the first housing relative to the second housing (block 606). For instance, image elements are displayed on the display device 106 in accordance with the correlated modified states. In one approach, image elements are assigned modified states by the display adapter module 110 and output on the display using the input/output module 104 of the computing device 102. Generally, the modified states determined by the display adapter module 110 define modifications to be made to the image when presented on a display at an inferred viewing angle.

Accordingly, techniques described herein enable a display of a computing device to output content arranged for viewing at a particular viewing angle. For instance, adaptive display techniques can be implemented to enable a user to view the display legibility when partially open. Further, the adaptive display techniques can be implemented by the described circuitry to enable the display of the computing device to present information and process interactions even while it is difficult to see the entire display.

Example System and Device

FIG. 7 illustrates an example system 700 that, generally, includes an example computing device 702 that is representative of one or more computing systems and/or devices that may implement the various techniques described herein. This is illustrated through inclusion of the display adapter module 110. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media, e.g., Flash memory, a removable hard drive, an optical disc, and so forth. The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch and to recognize user posture), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in one or more implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This is illustrated through inclusion of the display adapter module 110 the computing device 702. The functionality represented by the display adapter module 110 and other modules/applications may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

Implementations discussed herein include:

### EXAMPLE 1

A computing device comprising: a display device configured to display image elements; a first sensor configured to determine an angle of a first housing relative to a second housing of the computing device; a second sensor configured to determine an orientation of the computing device; and a display adapter circuit configured to perform operations comprising: processing hinge angle data from the first sensor and orientation data from the second sensor; inferring a viewing angle to output the image elements for display in dependence upon the hinge angle data and the orientation data; and adapting the display device to enable display of the image elements at the inferred viewing angle while the computing device is between a closed position and a fully open position.

### EXAMPLE 2

The computing device as described in example 1, wherein the display adapter circuit is configured to perform further operations including enabling interactive gestures related to the displayed image elements by reconfiguring a size and a shape of the displayed image elements in accordance with the inferred viewing angle.

### EXAMPLE 3

The computing device as described in one or more of examples 1 or 2, wherein the inferring the viewing angle includes determining a modified state from among a set of modified states that correlates a combination of the hinge angle data and the orientation data to different available viewing angles.

### EXAMPLE 4

The computing device as described in one or more of examples 1-3, wherein the second sensor configured to determine the orientation of the computing device includes using the second sensor to determine whether the computing device is being held.

### EXAMPLE 5

The computing device as described in one or more of examples 1-4, wherein the second sensor configured to determine the orientation of the computing device includes using the second sensor to determine a position of the computing device relative to an external environment.

### EXAMPLE 6

The computing device as described in one or more of examples 1-5, wherein to adapt the display device includes to continuously distort the image elements responsive to a change in a position of the computing device relative to an external environment.

### EXAMPLE 7

The computing device as described in one or more of examples 1-6, wherein the second sensor configured to determine the orientation of the computing device includes using a camera or an accelerometer disposed in the first housing or the second housing.

### EXAMPLE 8

A method implemented by a computing device, the method comprising: receiving, via a first orientation-determining technique, device orientation data indicative of a position of a first housing of the computing device relative to a second housing of the computing device; refining the position of the first housing relative to the second housing based on orientation data detected by a second orientation-determining technique; and modifying image elements on a display device of the computing device to enable viewing of the modified image elements in dependence upon the refined position of the first housing relative to the second housing.

### EXAMPLE 9

The method as described in example 8, wherein the refining the position of the first housing relative to the second housing includes inferring a viewing angle to output the image elements for display on the display device and the modifying includes distorting the image elements on the display device according to the inferred viewing angle.

### EXAMPLE 10

The method as described in one or more of examples 8 or 9, wherein the orientation data indicates whether the computing device is being held or is placed on a surface.

### EXAMPLE 11

The method as described in one or more of examples 8-10, wherein the computing device is a clamshell computing device.

### EXAMPLE 12

The method as described in one or more of examples 8-11, wherein the device orientation data is obtained by a hinge sensor disposed in a hinge that enables movement between the first and second housings.

### EXAMPLE 13

The method as described in one or more of examples 8-12, further comprising repeating the receiving, the refining, and the modifying responsive to a change in a position of the computing device.

### EXAMPLE 14

The method as described in one or more of examples 8-13, further comprising continuously updating display of the modified image elements on the display device in accordance with a change in the position of the first housing of the computing device relative to the second housing of the computing device.

### EXAMPLE 15

The method as described in one or more of examples 8-14, wherein the position of the first housing relative to the second housing indicates a degree of separation between the first and second housings.

### EXAMPLE 16

A method implemented by a computing device, the method comprising: receiving device orientation data indicative of a position of a first housing of the computing device relative to a second housing of the computing device; refining the position of the first housing relative to the second housing based on accelerometer data detected by the computing device; and transitioning display of image elements among multiple modified states on a display device of the computing device during a change of the position of the first housing relative to the second housing.

### EXAMPLE 17

The method as described in example 16, wherein each of the multiple modified states for the image elements represent different degrees of modification for the image elements such that the transitioning includes applying two or more of the multiple modified states during the change of the position of the first housing relative to the second housing.

### EXAMPLE 18

The method as described in one or more of examples 16 or 17, wherein at least one image element includes text and wherein at least one of the multiple modified states for the text identifies at least two dimensions at which to modify the text for display on the display device.

### EXAMPLE 19

The method as described in one or more of examples 16-18, wherein the image elements include information elements to provide information on the display device and gesture elements that are selectable to receive an input to invoke an action.

### EXAMPLE 20

The method as described in one or more of examples 16-19, wherein the display device is disposed on an inside surface of the first housing and extends to an outer edge of the first housing and wherein the transitioning display of the image elements among the multiple modified states on the display device of the computing device includes transitioning display of the image elements across the outer edge of the first housing to the inside surface of the first housing.

### CONCLUSION

Although the techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter, and other equivalent features and methods are intended to be within the scope of the appended claims. Further, various different embodiments are described and it is to be appreciated that each described embodiment can be implemented independently or in connection with one or more other described embodiments.

1. A method implemented by a computing device, the method comprising:
receiving, via a first orientation-determining technique, first orientation data indicative of a position of a first housing of the computing device relative to a second housing of the computing device;
refining the position of the first housing relative to the second housing based on second orientation data detected by a second orientation-determining technique; modifying image elements on a display device of the computing device to enable viewing of the modified image elements in dependence upon the refined position of the first housing relative to the second housing; and
modifying one or more of the image elements associated with an interactive gesture enabling performance of the interactive gesture from a viewing angle inferred by the refined position of the first housing relative to the second housing.

2. The method of claim 1, wherein the refining the position of the first housing relative to the second housing includes inferring the viewing angle to output the image elements for display on the display device and the modifying includes distorting the image elements on the display device according to the inferred viewing angle.

3. The method of claim 1, wherein the first orientation data indicates whether the computing device is being held or is placed on a surface.

4. The method of claim 1, further comprising repeating the receiving, the refining, and the modifying responsive to a change in a position of the computing device.

5. The method of claim 1, wherein the first orientation data is obtained by a hinge sensor disposed in a hinge that enables movement between the first and second housings.

6. The method of claim 1, wherein the modifying the image elements on the display device occurs while the computing device is between a closed position and a fully open position.

7. The method of claim 1, further comprising continuously updating display of the modified image elements on the display device in accordance with a change in the position of the first housing of the computing device relative to the second housing of the computing device.

8. The method of claim 1, wherein the position of the first housing relative to the second housing indicates a degree of separation between the first and second housings.

9. A computing device comprising:
a display device configured to display image elements;
a first sensor configured to determine an angle of a first housing relative to a second housing of the computing device;
a second sensor configured to determine an orientation of the computing device; and
a display adapter circuit configured to:
receive hinge angle data from the first sensor and orientation data from the second sensor;
infer a viewing angle to output the image elements for display in dependence upon the hinge angle data and the orientation data;
adapting adapt the display device to enable display of the image elements at the inferred viewing angle while the computing device is between a closed position and a fully open position; and
reconfigure one or more of the image elements associated with an interactive gesture enabling performance of the interactive gesture in accordance with the inferred viewing angle.

10. (canceled)

11. The computing device of claim 9, wherein the display adapter circuit is configured to infer the viewing angle based on a determination of a modified state from among a set of modified states that correlates a combination of the hinge angle data and the orientation data to different available viewing angles.

12. The computing device of claim 9, wherein the second sensor configured to determine the orientation of the computing device includes using the second sensor to determine whether the computing device is being held.

13. The computing device of claim 9, wherein the second sensor configured to determine the orientation of the computing device includes using the second sensor to determine a position of the computing device relative to an external environment.

14. The computing device of claim 9, wherein to adapt the display device includes to continuously distort the image elements responsive to a change in a position of the computing device relative to an external environment.

15. The computing device of claim 9, wherein the second sensor configured to determine the orientation of the computing device includes using a camera or an accelerometer disposed in the first housing or the second housing.

16. A method implemented by a computing device, the method comprising:
receiving device orientation data indicative of a position of a first housing of the computing device relative to a second housing of the computing device;
refining the position of the first housing relative to the second housing based on accelerometer data detected by the computing device;
transitioning display of image elements among multiple modified states on a display device of the computing device during a change of the position of the first housing relative to the second housing; and
modifying one or more of the image elements associated with an interactive gesture enabling performance of the interactive gesture from a viewing angle inferred by the refined position of the first housing relative to the second housing.

17. The method of claim 16, wherein each of the multiple modified states for the image elements represent different degrees of modification for the image elements such that the transitioning includes applying two or more of the multiple modified states during the change of the position of the first housing relative to the second housing.

18. The method of claim 16, wherein at least one image element includes text and wherein at least one of the multiple modified states for the text identifies at least two dimensions at which to modify the text for display on the display device.

19. The method of claim 16, wherein the image elements include information elements to provide information on the display device and gesture elements that are selectable to receive an input to invoke an action.

20. The method of claim 16, wherein the display device is disposed on an inside surface of the first housing and extends to an outer edge of the first housing and wherein the transitioning display of the image elements among the multiple modified states on the display device of the computing device includes transitioning display of the image elements across the outer edge of the first housing to the inside surface of the first housing.

21. The method of claim 16, wherein the device orientation data is collected at least in part using a camera or an accelerometer of the computing device.
